(19) United States
(12) Patent Application Publication
(10) Pub. No.: US 2018/0198302 A1
(43) Pub. Date: Jul. 12, 2018

(54) MOBILE POWER SOURCE

(71) Applicant: SHENZHEN LAIDIAN TECHNOLOGY CO., LTD., SHENZHEN, GUANGDONG (CN)

(72) Inventors: Weige YU, SHENZHEN, GUANGDONG (CN); Xiaoyi YE, SHENZHEN, GUANGDONG (CN); Fengchi XIAO, SHENZHEN, GUANGDONG (CN); Xiaowei ZHENG, SHENZHEN, GUANGDONG (CN); Baoming TANG, SHENZHEN, GUANGDONG (CN); Guansheng YAN, SHENZHEN, GUANGDONG (CN); Bingsong YUAN, SHENZHEN, GUANGDONG (CN); Qiongying ZHUANG, SHENZHEN, GUANGDONG (CN)

(73) Assignee: SHENZHEN LAIDIAN TECHNOLOGY CO., LTD., SHENZHEN, GUANGDONG (CN)

(21) Appl. No.: 15/757,527

(22) PCT Filed: Jul. 19, 2016
(86) PCT No.: PCT/CN2016/090419

§ 371 Date: Mar. 5, 2018

(30) Foreign Application Priority Data
Sep. 7, 2015 (CN) 201520691258.0

(51) Int. Cl. H02J 7/00; H01M 10/46

(52) U.S. Cl. CPC H02J 7/0054; H01M 10/46; H01M 2/1016; H01M 2220/30; H02J 2007/0062; H02J 7/0045

(57) ABSTRACT

A mobile power source includes an upper cover, a charging battery, a circuit board, a group of charging input metal contacts and a lower cover. The upper cover and lower cover match to form a mobile power source case, and the charging battery and group of charging input metal contacts are respectively electrically connected to the circuit board. The charging battery and circuit board are accommodated in the mobile power source case, and the group of charging input metal contacts are exposed outside of the mobile power source case.

### CROSS-REFERENCE TO RELATED APPLICATIONS

This is a national stage application filed under 35 U.S.C. 371 of pending international application PCT/CN2016/090419, filed Jul. 19, 2016, which claims priority to Chinese patent application CN 201520691258.0, filed Sep. 7, 2015, the entirety of which applications are incorporated by reference herein.

### TECHNICAL FIELD

The present disclosure pertains to the field of power source, and particularly relates to a mobile power source.

### BACKGROUND

The current mobile power sources on the market are basically charged via a Micro USB interface, and in such a charging mode, for situations or devices requiring heavy use of a mobile power source, since it is required to manually insert charging lines into the Micro USB interface of the mobile power source one by one, the efficiency is very low; however, if the operation is made by a machine, the machine is required to have a very high accuracy.

### SUMMARY

Embodiments of the present disclosure provides a mobile power source, comprising an upper cover, a charging battery, a circuit board, a group of charging input metal contacts and a lower cover. The upper cover and lower cover match to form a mobile power source case, the charging battery and the group of charging input metal contacts are respectively electrically connected to the circuit board, the charging battery and the circuit board are accommodated in the mobile power source case, and the group of charging input metal contacts are exposed outside of the mobile power source case.

In an example, the upper cover and the lower cover match to form the mobile power source case by means of a buckle or ultrasonic welding.

In an example, the group of charging input metal contacts are electrically connected to a charging input of the circuit board.

In an example, the charging battery is electrically connected to a charging output of the circuit board.

In an example, the group of charging input metal contacts are exposed outside of a side where the upper cover and the lower cover match.

In an example, the power mobile source further comprises another group of charging input metal contacts or a plurality of groups of charging input metal contacts, wherein each group of charging input metal contacts is exposed outside of a different side of the mobile power source case.

In an example, the charging input metal contacts are of a round or square shape.

In an example, each group of charging input metal contacts at least include two charging input metal contacts, wherein one charging input metal contact is electrically connected to a positive electrode of the charging input of the circuit board, and the other charging input metal contact is electrically connected to a negative electrode of the charging input of the circuit board.

In an example, the mobile power source further comprises a MICRO USB interface electrically connected to the charging input of the circuit board, and/or a MINI USB interface electrically connected to the charging input of the circuit board, wherein both the MICRO USB interface and the MINI USB interface are exposed outside of the mobile power source case.

In an example, the mobile power source further comprises a power source output USB interface electrically connected to the circuit board, wherein the power source output USB interface is exposed outside of the mobile power source case.

In the disclosure, since the charging input metal contacts serve as charging inputs, the charging is available if the charging input metal contacts of the mobile power source are aligned with a charging base with a spring contact or spring member; since the charging input metal contacts have a certain surface area, even if the charging is made by aligning the mobile power source with the charging base through a machine, the machine is not required to have a high accuracy, and it is only required to ensure that the spring contact or spring member on the charging base contacts with the charging input metal contacts. Further, since the operation can be made by a machine, it has a high operating efficiency for situations or devices requiring heavy use of a mobile power source.

### BRIEF DESCRIPTION OF THE DRAWINGS

FIG. 1 is an exploded view of a mobile power source provided by an embodiment of the disclosure.

FIG. 2 is a schematic view of the mobile power source provided by the embodiment of the disclosure.

### DETAILED DESCRIPTION

Embodiments of the disclosure provide a mobile power source, which aims to solve the following problem: the mobile power source that is charged via the Micro USB interface has a very low manual operating efficiency, but if the operation is made by a machine, the machine is required to have a very high accuracy.

In order to make the objective, technical solution and beneficial effects of the disclosure clearer, the disclosure will be further described in detail below in combination with the accompanying drawings and the embodiments. It should be appreciated that, the embodiments described herein are merely used for explaining the disclosure but not for limiting the disclosure.

In order to describe the technical solution of the disclosure, the following embodiments are provided.

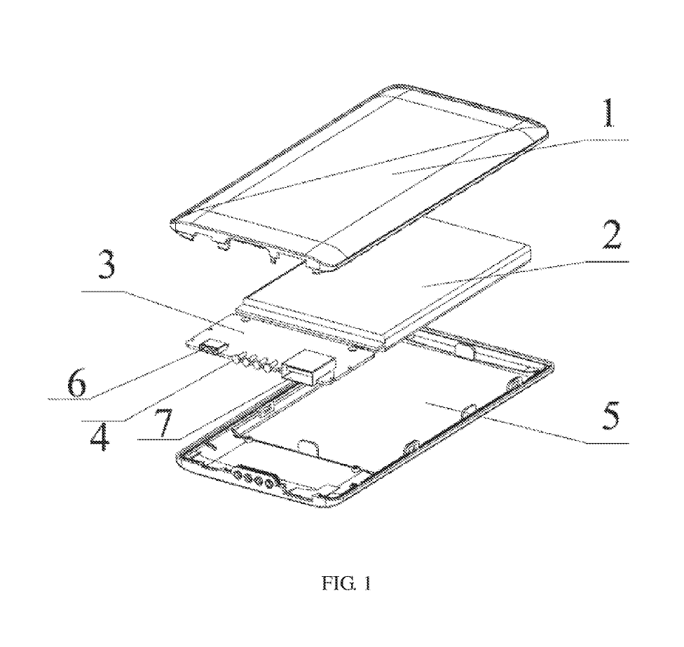

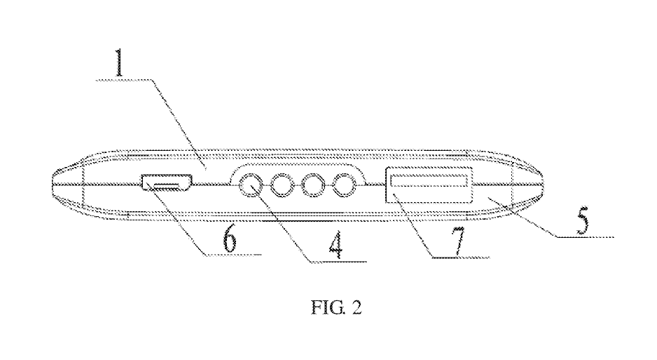

Please refer to FIG. 1 and FIG. 2, the mobile power source provided by an embodiment of the disclosure comprises an upper cover 1, a charging battery 2, a circuit board 3, a group of charging input metal contacts 4 and a lower cover 5. The upper cover 1 and lower cover 5 match to form a mobile power source case, the charging battery 2 and the group of charging input metal contacts 4 are respectively electrically connected to the circuit board 3, the charging battery 2 and the circuit board 3 are accommodated in the mobile power source case, and the group of charging input metal contacts 4 are exposed outside of the mobile power source case.

The circuit board 3 in the embodiment of the disclosure can achieve the functions of charging and discharging management and protection of the charging battery 2.

In the embodiment of the disclosure, the upper cover 1 and the lower cover 5 match to form the mobile power source case, specifically by means of a buckle or ultrasonic welding. The group of charging input metal contacts 4 specifically are electrically connected to a charging input of the circuit board 3, and the charging battery 2 is electrically connected to a charging output of the circuit board 3. The group of charging input metal contacts 4 specifically are exposed outside of a side where the upper cover 1 and the lower cover 5 match. Of course, the power mobile source may also comprise two groups of charging input metal contacts or a plurality of groups of charging input metal contacts, wherein each group of charging input metal contacts are exposed outside of a different side of the mobile power source case, such that the charging can be successful even if the orientation of the mobile power source is wrongly placed during the charging. Each group of charging input metal contacts at least include two charging input metal contacts, wherein one charging input metal contact is electrically connected to a positive electrode of the charging input of the circuit board 3, and the other charging input metal contact is electrically connected to a negative electrode of the charging input of the circuit board 3. The charging input metal contacts may be of a round or square shape or others.

The mobile power source provided by the embodiment of the disclosure may further comprise a MICRO USB interface electrically connected to the charging input of the circuit board 3, and/or a MINI USB interface 6 electrically connected to the charging input of the circuit board 3, wherein both the MICRO USB interface and the MINI USB interface 6 are exposed outside of the mobile power source case.

The mobile power source provided by the embodiment of the disclosure may further comprise a power source output USB interface 7 electrically connected to the circuit board 3, wherein the power source output USB interface is exposed outside of the mobile power source case, and can directly charge a mobile product by connecting charging lines to the power source output USB interface.

In the disclosure, since the charging input metal contacts serve as charging inputs, the charging is available if the charging input metal contacts of the mobile power source are aligned with the charging base with a spring contact or spring member; since the charging input metal contacts have a certain surface area, even if the charging is made by aligning the mobile power source with the charging base through a machine, the machine is not required to have a high accuracy, and it is only required to ensure that the spring contact or spring member on the charging base contacts with the charging input metal contacts. Further, since the operation can be made by a machine, it has a high operating efficiency for situations or devices requiring heavy use of a mobile power source.

The above only describes advantageous embodiments of the disclosure and is not used for limiting the disclosure, and any modification, equivalent replacement and improvement made within the spirit and rule of the disclosure should be embraced in the scope of protection of the disclosure.

1. A mobile power source comprising an upper cover, a charging battery, a circuit board, a group of charging input metal contacts and a lower cover, wherein the upper cover and lower cover match to form a mobile power source case, the charging battery and the group of charging input metal contacts are respectively electrically connected to the circuit board, the charging battery and the circuit board are accommodated in the mobile power source case, and the group of charging input metal contacts are exposed outside of the mobile power source case, wherein the power mobile source further comprises another group of charging input metal contacts or a plurality of groups of charging input metal contacts, wherein each group of charging input metal contacts is exposed outside of a different side of the mobile power source case.

2. The mobile power source according to claim 1, wherein the upper cover and the lower cover match to form the mobile power source case by means of a buckle or ultrasonic welding.

3. The mobile power source according to claim 1, wherein the group of charging input metal contacts are electrically connected to a charging input of the circuit board.

4. The mobile power source according to claim 1, wherein the charging battery is electrically connected to a charging output of the circuit board.

5. The mobile power source according to claim 1, wherein the group of charging input metal contacts are exposed outside of a side where the upper cover and the lower cover match.

6. (canceled)

7. The mobile power source according to claim 1, wherein the charging input metal contacts are of a round or square shape.

8. The mobile power source according to claim 1, wherein each group of charging input metal contacts at least includes two charging input metal contacts, wherein one charging input metal contact is electrically connected to a positive electrode of the charging input of the circuit board, and the other charging input metal contact is electrically connected to a negative electrode of the charging input of the circuit board.

9. The mobile power source according to claim 1, wherein the mobile power source further comprises a MICRO USB interface electrically connected to the charging input of the circuit board, and/or a MINI USB interface electrically connected to the charging input of the circuit board, wherein both the MICRO USB interface and the MINI USB interface are exposed outside of the mobile power source case.

10. The mobile power source according to claim 1, wherein the mobile power source further comprises a power source output USB interface electrically connected to the circuit board, wherein the power source output USB interface is exposed outside of the mobile power source case.
